(19) United States
(12) Patent Application Publication
(10) Pub. No.: US 2005/0208276 A1
(43) Pub. Date: Sep. 22, 2005

(54) Covering film including a decorative layer

(75) Inventors: Mael Pommeret, Lyon (FR); Fabian Del Wal, Chalamont (FR)

Correspondence Address: James R. Williams;Jameson, Seltzer, Harper & Williams, 2625 Wilmington Road, New Castle, PA, 16105, US

(73) Assignee: Compagnie Pastic Omnium, Lyon (FR)

(21) Appl. No.: 10/818,701

(22) Filed: Apr. 6, 2004

(30) Foreign Application Priority Data
Apr. 8, 2003 (FR) FR0304354

(51) Int. Cl. B32B 3/00

(52) U.S. Cl. 428/195.1

(57) ABSTRACT

A film for covering a plastics material part, the film comprising a transparent protective layer and a decorative layer, the decorative layer resulting from the superposition of at least one first and one second pattern printed successively on the protective layer, wherein the first pattern printed on the protective layer is constituted by a non-covering tint.

### FIELD OF THE INVENTION

The invention relates to a covering film for a plastics material part, and to a part made of plastics material and covered in such a film.

The invention applies in particular to the field of plastics material parts for the automobile industry, and in particular to parts having a decorative function.

### SUMMARY OF THE INVENTION

An object of the invention is to provide a covering film that produces an original decorative effect, while being simple and inexpensive to make.

The present invention provides a film for covering a plastics material part, the film comprising a transparent protective layer and a decorative layer, the decorative layer resulting from the superposition of at least one first and one second pattern printed successively on the protective layer, wherein the first pattern printed on the protective layer is constituted by a non-covering tint.

According to the invention, “non-covering” means that the tint presents opaqueness that is insufficient to mask the layer(s) of ink onto which the pattern is printed.

In this way, the underlying patterns are visible, but only if the lighting conditions and the viewing angle make that possible. In particular, it is the angle at which light is reflected on the film that determines whether the underlying patterns are visible.

Thus, if the film covers a three-dimensional part, different designs appear at different locations of the film, said designs being constituted solely by the first pattern, or by another pattern, or by a combination of both of them.

Preferably, all of the patterns printed in succession on the protective layer are constituted by non-covering tints.

Under such circumstances, superposing tints at pattern locations that coincide locally for two different patterns increases the opaqueness of the resulting tint locally and provides another variant visual effect, which likewise appears more or less clearly depending on conditions of illumination and of observation.

In a first particular embodiment, the film comprises a background layer constituted by a covering tint, optionally of metallic appearance. This layer serves to increase the contrast between zones of shade and light and also to vary contrast between the background layer and the patterns.

More generally, it is advantageous for at least one of the tints to be metallic, and preferably for all of them to be metallic because of the improved visual rendering that is obtained.

In another embodiment, in order to cause one or another of the patterns to appear or disappear as a function of lighting and observation conditions, the invention proposes using tints that form a cameo (one color with several tones) with another tint, e.g. with the background tint.

The invention also provides a plastics material part covered in a film as described above.

### BRIEF DESCRIPTION OF THE DRAWINGS

In order to make the invention easier to understand, there follows a description of an embodiment that does not limit the scope of the invention, the description being given with the help of the accompanying drawings, in which:

FIG. 1 is a diagrammatic view of the principle of combining superposed patterns on a film in an embodiment of the invention;

FIG. 2 shows an example of the resulting overall visual rendering;

FIG. 3 is a view analogous to FIG. 1 and corresponds to a film provided with a protective layer and carried by a substrate, in another embodiment;

FIG. 4 is a diagram showing zones of different brightness in the film when it is given a three-dimensional shape;

FIG. 5 is a diagram showing how the patterns are combined as obtained in the zones of differing brightness, for patterns made with identical non-covering tints;

FIG. 6 shows an example of the resulting overall visual effect for a given viewing angle at a given angle of incident light;

FIG. 7 is a view analogous to FIG. 5 for patterns made using covering tints forming a cameo; and

FIG. 8 shows an example of the resulting overall visual effect obtained for a given viewing angle and a given angle of incidence of light.

### DETAILED DESCRIPTION OF THE INVENTION

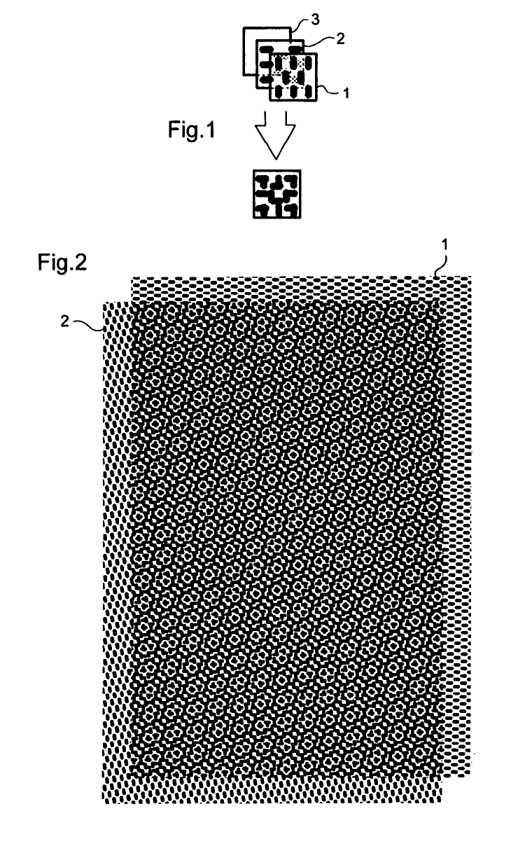

FIG. 1 is a diagram showing two patterns 1 and 2 superposed on a metallic background 3. Each pattern is constituted by a set of identical spots of pseudo-oval shape.

For each pattern, the spots are identically oriented and they are distributed at the nodes of a regular array of square mesh.

The long direction for the spots in pattern No. 1 is different from the long direction for the spots in pattern No. 2.

The two patterns are superposed, as shown in FIG. 1, but the exact positioning of one pattern relative to the other does not matter.

The combination of these two patterns is shown in FIG. 1. In this example, where the tints of the two patterns are opaque, the spots of the two patterns mask the metallic background whose brightness coming from the reflection of light creates varying contrast between the background and the patterns. In other words, the luminous contrast between zones of shade and zones of light is greater for the background than for the patterns.

An interesting characteristic of combining two patterns is that it enables a regular design to be obtained, regardless of the relative positioning between the two patterns and as can be seen in FIG. 2.

The regularity of the design makes it appear that this combination is predetermined, whereas in fact it is nothing other than the result of the random positioning of the two patterns relative to each other.

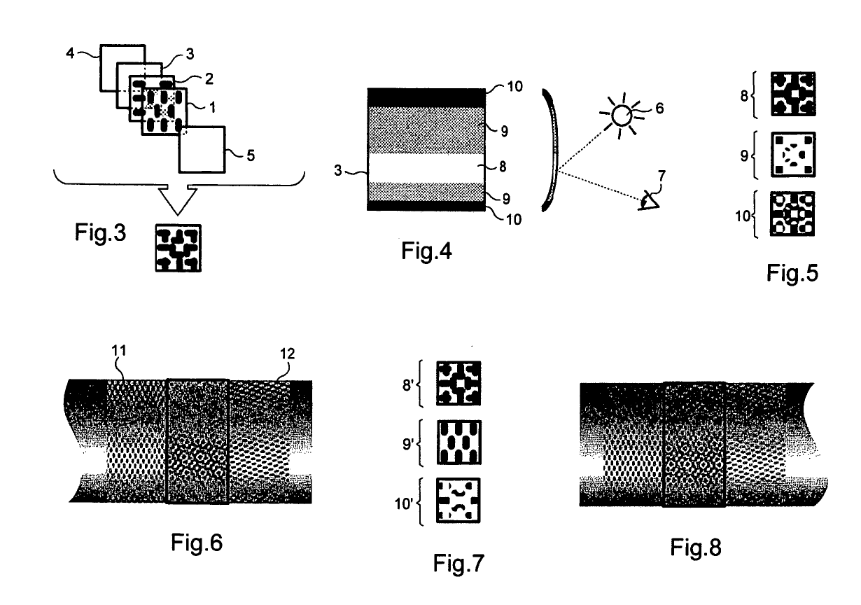

FIG. 3 shows not only the metallic background 3 and the two patterns 1 and 2 as described above, but also a substrate 4 and a transparent protective layer 5 which protects the film.

From a practical point of view, this transparent protective layer is a layer of transparent plastics material on which the two patterns and then the background are printed in succession. The printed transparent layer and the substrate are then united by any appropriate means.

FIG. 4 shows various zones of differing brightness for the metallic background 3.

Depending on the position of a light source 6 and of a point of observation 7, light rays reflected by the metallic background confer varying brightness to the metallic background. This varying brightness can be subdivided into three zones, namely a zone 8 in which reflection is direct, a zone 9 contiguous with the zone 8 in which reflection is indirect, and a zone 10 remote from the zone 8 in which there is practically no reflection.

FIG. 5 shows the result of combining patterns and background brightness in each of the zones 8, 9, and 10 for two identical square mesh array patterns 11 and 12 in which the spots do not have the same orientation in both patterns.

The direct reflection zone 8 provides maximum lighting. Contrast therein is very marked between the metallic background and the spots of the patterns which, although not opaque, appear to be opaque, such that the resulting decorative effect is similar to that of FIG. 2, where the spots appear to be opaque.

In indirect reflection zone 9, which benefits from less illumination, only those regions in which the spots are superposed appear to be opaque, with the others presenting a level of brightness that is close to that of the metallic background and becoming merged therewith. The resulting pattern has an overall visual rendering that is significantly different from that of the zone 8.

In zone 10, the brightness of the metallic background layer is low. The spots mask the base layer except at locations where they are superposed, and their reflecting nature is similar to that of the background layer. This results in a design which is complementary to the design obtained in zone 9.

This deign provides an overall visual effect that can be seen more clearly in FIG. 6, in which a first region situated to the left in the figure shows only the first pattern 11, a second region situated to the right in the figure shows only the second pattern 12, and the central region corresponds to a combination of the two patterns, as seen in the zone 9.

FIG. 7 shows in a manner analogous to FIG. 5, the combinations of the patterns 11 and 12 when the tints used form a cameo, i.e. when the tints are obtained using a single color but with different tones.

The tint of the background layer may be provided by the substrate, without additional printing on the patterns printed on the protective layer. This possibility also exists for patterns of identical tints.

Under such circumstances, the bright zone 8′ of the background layer produces an effect similar to the zone 8 of FIG. 5.

In contrast, the zone 9′ allows only the first pattern 11 to be seen, while the zone 10′ allows only the second pattern 12 to be seen in regions where it is not superposed on the first pattern 11.

The resulting overall visual effect can be seen in FIG. 8, which is analogous to FIG. 6.

It can thus be seen that by means of the invention the resulting decorative effect for a three-dimensional plastics material part varies as a function of the angle at which it is observed.

The invention enables this original decorative characteristic to be obtained by means that are simple.

1. A film for covering a plastics material part, the film comprising a transparent protective layer and a decorative layer, the decorative layer resulting from the superposition of at least one first and one second pattern printed successively on the protective layer, wherein the first pattern printed on the protective layer includes a non-covering tint.

2. The film of claim 1, wherein the patterns printed in succession on the protective layer include non-covering tints.

3. The film of claim 1, including a background layer comprising a covering tint.

4. The film of claim 1, wherein the non-covering tint comprises a metallic tint.

5. The film of claim 3, wherein the non-covering tint forms a cameo with the covering tint.

6. The film of claim 1, wherein the first and second patterns are identical but mutually offset.

7. The film of claim 1, wherein the first and second patterns are identical but differently oriented.
